(19) United States
(12) Patent Application Publication
(10) Pub. No.: US 2010/0056267 A1
(43) Pub. Date: Mar. 4, 2010

(54) GAME SYSTEM AND METHOD PROVIDING CARD SYMBOLS COLLECTION

(75) Inventors: Chih-Li Chang, Taipei City (TW); Chang-Hsien Tsai, Luodong Town (TW); Ching-Yi Kao, Taichung County (TW)

Correspondence Address: Muncy, Geissler, Olds & Lowe, PLLC, P.O. BOX 1364, FAIRFAX, VA, 22038-1364, US

(73) Assignee: JUMBO TECHNOLOGY CO., LTD., Shituen Chiu (TW)

(21) Appl. No.: 12/199,500

(22) Filed: Aug. 27, 2008

(51) Int. Cl. A63F 9/24; A63F 13/00

(52) U.S. Cl. 463/27; 463/20

(57) ABSTRACT

A game system and method capable of collecting card symbols includes a game machine, a card symbol judging unit and a card symbol collecting unit. The game machine has a plurality of wheels which are arranged in juxtaposed and array fashion to generate a card set. Each wheel has card symbols that appear randomly. The card symbol judging unit judges whether the card symbols of the card set meet a special requirement. If confirmed positive, a selected amount of bonus game is granted. During the bonus game, special card symbols selected from a specific card symbol combination can randomly appear. The card symbol collecting unit records and collects the appeared special card symbols. When the bonus game ends, based on the collection result, a judgment is made on whether to grant points or an extra amount of the bonus game to repeat playing of the bonus game.

### FIELD OF THE INVENTION

The present invention relates to a game machine and particularly to a game system and method capable of collecting card symbols to enhance amusement.

### BACKGROUND OF THE INVENTION

Wheel-type game machines such as slot machines and fruit machines provide games for players. At the end of the game, the player gets a score. They are quite popular. The conventional wheel-type game machine has a plurality of wheels arranged in a juxtaposed and array fashion to form a card set. Each wheel can rotate independently to randomly change the card symbol of the wheel to generate a different card set. In the event that the card symbols of abutting wheels are the same consecutively, an alignment is formed. In one card set, if the alignment occurs to more wheels or rare card symbols, the player gets more points.

On the conventional wheel-type game machine, the player performs machine operation individually and repeatedly to accumulate the points through happening of the alignment of the card symbols. The player tends to feel tired and bored after playing for a period of time. Such a mechanical and repetitive operation makes the player losing interest quickly.

### SUMMARY OF THE INVENTION

Therefore, the primary object of the present invention is to provide a game system capable of collecting hit card symbols. The invention also offers a bonus game in which collectable special card symbols in a card set appear randomly. The player can earn more points through collection or play extra bonus game. Thus the player has the fun of collection and more interest in playing.

The game system according to the invention includes a game machine, a card symbol judging unit and a card symbol collecting unit. A player starts the game machine to play games. The game machine has a plurality of wheels arranged in a juxtaposed fashion. Each wheel has card symbols that appear randomly. A card set can be generated through the wheels to count score. The card symbol judging unit judges whether the card symbols of the card set meets a special requirement. In the event that the special requirement is met, a selected amount of bonus game is provided to be played on the game machine. Different additional points are granted according to different alignments. During the bonus game, the wheels in the card set can randomly present special card symbols selected from a specific card symbol combination. The card symbol collecting unit records and collects the appeared special card symbols to repeat the bonus game and get scores. After the amount of the bonus game is used up, whether to grant additional points or extra amount of the bonus game to play at least one more round thereof is determined according to the collection result. Hence it can satisfy player's desire of collection and enhance playing interest.

Thus through the bonus game and collection of the special card symbols, the player's desire for collecting card symbols to earn additional points can be kindled and satisfied. The bonus game provides collectable special card symbols to allow the player to earn more points or additional round of playing. Thus the game is more interesting and appealing, and offers the player more incentives and anticipating excitement to play the game.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the invention.

FIG. 2 is a schematic view of a card set of the invention.

FIG. 3 is a schematic view of another card set of the invention.

FIG. 4 is a schematic view of a collection display zone of the invention.

FIG. 5 is a game flowchart on the game machine according to the invention.

FIG. 6 is a game flowchart of the bonus game according to the invention.

FIG. 7 is a schematic view of a card set of a bonus game according to the invention.

FIG. 8 is a schematic view of a special card symbol recorded in the collection display zone.

FIG. 9 is a schematic view of another special card symbol recorded in the collection display zone.

FIG. 10 is a schematic view of another embodiment of the wheels of the invention.

### DETAILED DESCRIPTION OF THE PREFERRED EMBODIMENTS

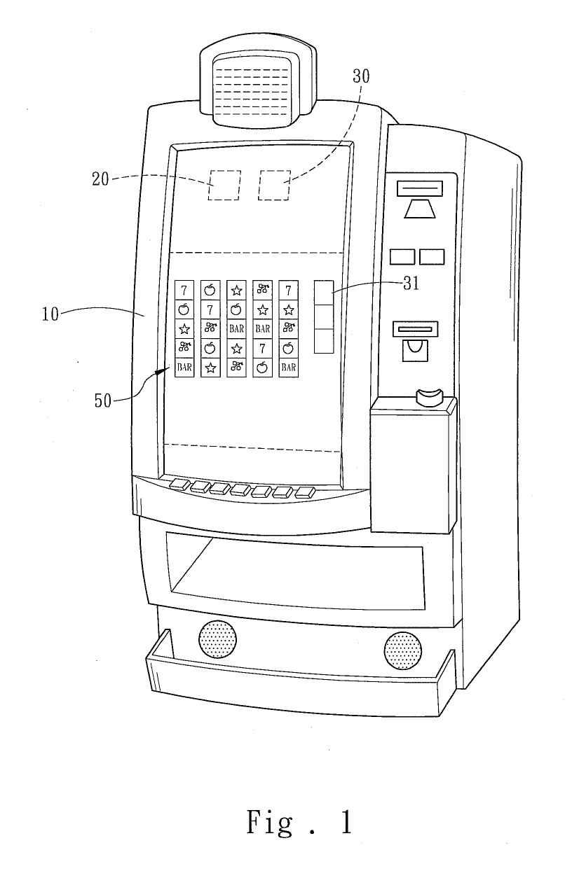

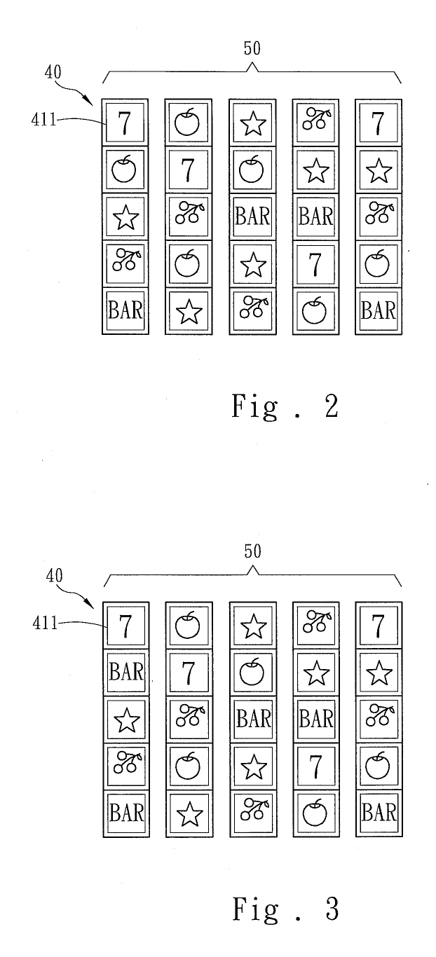

Please refer to FIGS. 1 and 2 for an embodiment of the invention. The invention includes a game machine 10, a card symbol judging unit 20 and a card symbol collecting unit 30. The game machine 10 has a plurality of wheels 40 arranged in an array to generate a card set 50. Various types of card symbols 411 on each wheel 40 of the card set 50 can appear randomly. In the embodiment, there are twenty five wheels 40 arranged in an array of five rows and five columns.

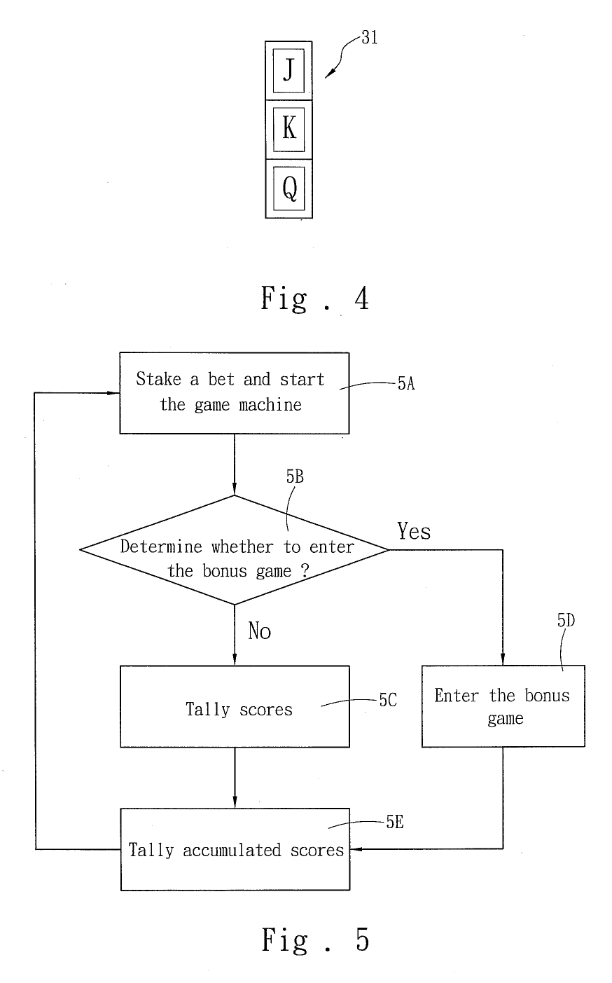

Refer to FIGS. 3 and 4, the card symbol judging unit 20 and the card symbol collecting unit 30 in the game machine 10 provide control units. In the event that the card symbol judging unit 20 judges that the card symbol 411 of the card set 50 meets a special requirement, such as in FIG. 3 in which “BAR” appears five times or more on the card symbols 411, a bonus game of a specific amount is granted on the game machine 10, or a specific amount of the bonus game can be proceeded when the accumulated points have reached a set threshold. When the game machine 10 proceeds the bonus game, each wheel 40 in the card set 50 randomly presents a special card symbol selected from a specific card symbol combination. For instance, in one round of the bonus game, the specific card symbol combination consists of “J”, “Q” and “K” of poker cards. The card symbol collecting unit 30 records and collects the appeared specific card symbols. Referring to FIG. 4, through a collection display zone 31 the card symbol collecting unit 30 displays the collected specific card symbols. When the amount of the bonus game is used up, whether points are earned or an additional amount of bonus game is awarded for one more bonus game is determined according to the collecting result. In the event that the three card symbols of “J”, “Q” and “K” are fully collected, a selected quantity of points are given to the player, or an additional amount of the bonus game is awarded to the player to continue game playing.

The invention also provides a method for the game system previously discussed. Refer to FIG. 5 for the flowchart of the method according to the invention. It includes steps 5A, 5B, 5C, 5D and 5E. At the initial step 5A, the player selects a bet and starts the game machine 10 to play the game. The wheels 40 rotate and randomly generate the card set 50. At step 5B, whether the card symbol 411 of the card set 50 meets a special requirement to enter the bonus game is judged. The judgment is performed by the card symbol judging unit 20. In the event that the card symbol 411 of the card set 50 meets the special requirement, such as the accumulated points have reached the set threshold or a special card set 50 has appeared, proceed step 5D in which a specific amount of the bonus game is provided, and enter the bonus game on the game machine 10. If the special requirement is not met, proceed step 5C and tally the scores. Points are counted according to alignment result. Step 5E is the final step, accumulated points are tallied, and proceed playing of the game of a next round.

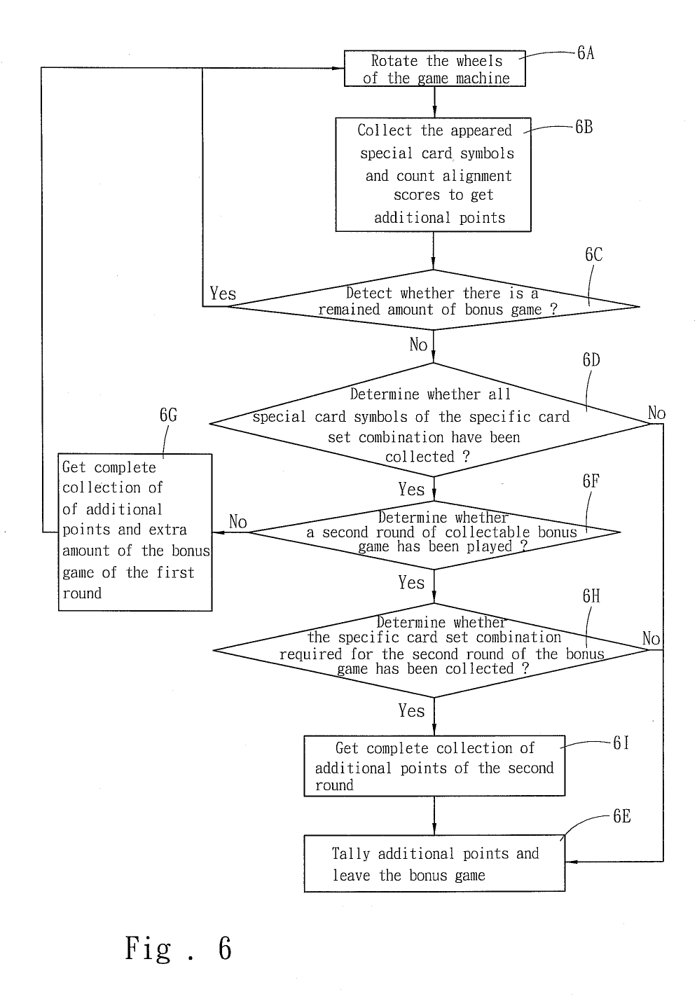

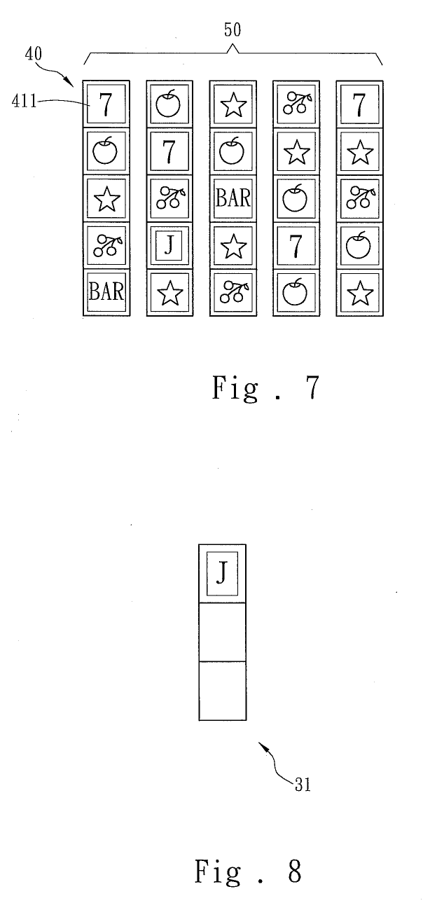

Refer to FIG. 6 for the flowchart of the bonus game according to the invention. It includes steps 6A through 6I. First, at step 6A, the wheels 40 of the game machine 10 rotate for the first round of the bonus game to perform collection. Each of the wheels 40 can randomly present a special card symbol selected from a specific card symbol combination. For instance, the specific card symbol combination consists of “J”, “Q” and “K” of poker cards that may appear randomly in the card set 50, such as ‘J” appears in the card set 50 shown in FIG. 7.

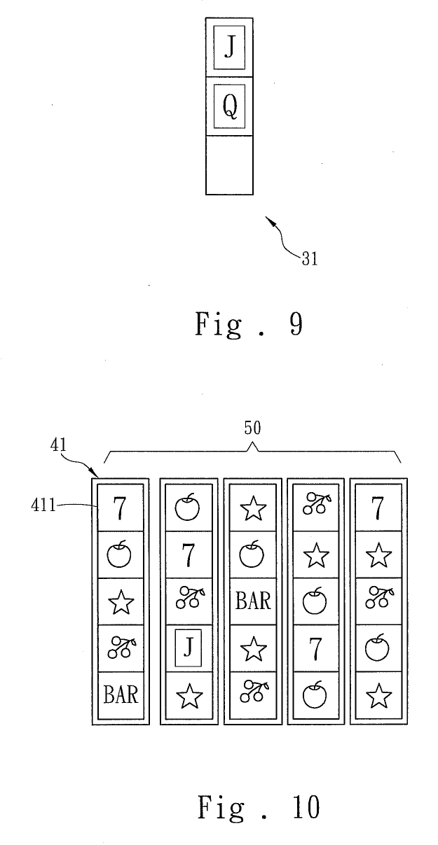

At step 6B, the card symbol collecting unit 30 records and collects the appeared special card symbol, and tallies the alignment score to get additional points. Referring to FIG. 8, the collected special card symbol is displayed on the collection display zone 31 by the card symbol collecting unit 30. At step 6C, detect whether there is a remained amount of the bonus game; if positive, repeat step 6A and rotate the wheels 40 to proceed the game until the amount of the bonus game is exhausted. The card symbol collecting unit 30 records and collects new special card symbols that have appeared, and displays on the collection display zone 31 as shown in FIG. 9, with an additional entry of the special card symbol “Q”.

In the event that there is no remained amount of the bonus game, proceed step 6D. Based on the collected special card symbols recorded by the card symbol collecting unit 30, a judgment is made on whether the collected card symbols contain all the special card symbols in the specific card symbol combination; if negative, proceed step 6E, count additional points being gained and leave the bonus game; if positive, proceed step 6F, and judge whether the bonus game for a second round collection has been executed.

At step 6F, if the bonus game for the second round collection is judged not yet being executed, proceed step 6G to get additional points resulting from complete collection of the first round, and increase the amount of the bonus game, then repeat step 6A to proceed the second round of the collectable bonus game.

The process flow of the bonus game for the second round collection is substantially like the first round collection. It also is proceeded by rotating the wheels 40, and recording collection of the special card symbols through the card symbol collecting unit 30. However, the specific card symbol combination of the second round is different from the first round. The special card symbols to be collected in the second round have a lower appearing probability but greater variety. For instance, the specific card symbol combination may consist of various card types of the poker cards, namely including special card symbols of “spade”, “heart”, “club” and “diamond”.

After the times of bonus game of the second round collection are used up, based on the judgments at steps 6C, 6D and 6F, directly enter step 6H to judge whether the collected special card symbols in the second round recorded by the card symbol collecting unit 30 have met the condition of the specific card symbol combination required for the bonus game. If negative, proceed step 6E to count the additional points being gained. If positive, proceed step 6I to get the additional points of the second round collection, then proceed step 6E to count accumulation of the addition points.

Referring to FIG. 10, the wheels 41 of the invention may also have respectively a plurality of card symbols 411 arranged in up and down manner and configured in a juxtaposed and array fashion to form alignment to generate the card set 50.

As a conclusion, the invention provides a design with a bonus game and collection of special card symbols can enhance game diversity to kindle player's anticipation and enable players to enjoy the fun of collection. Thus the game is more interesting and can enhance player's anticipation and pleasure.

What is claimed is:

1. A game system providing card symbols collection, comprising:
a game machine having a plurality of wheels arranged in an array to generate a card set in which each wheel randomly presenting a card symbol;
a card symbol judging unit providing a selected amount of a bonus game to be proceeded on the game machine after having judged that the card symbol of the card set having met a special requirement, each wheel of the card set in the bonus game randomly presenting a special card symbol selected from a specific card symbol combination; and
a card symbol collecting unit to record and collect the presented special card symbol and determine when the amount of the bonus game is used up whether to grant points or increase the amount of the bonus game to restart the bonus game according to collection result.

2. The game system of claim 1, wherein the wheels are twenty five in number and arranged in the array of five rows and five columns.

3. The game system of claim 1, wherein the special requirement is having the points accumulated to reach a set threshold.

4. The game system of claim 1, wherein the special requirement is appearing of a specific card set.

5. The game system of claim 1, wherein the wheels have respectively a plurality of card symbols arranged in an up and down manner, and configured in a juxtaposed fashion to form the array to form an alignment and generate the card set.

6. A method of game for providing card symbols collection, comprising the steps of:
selecting a bet amount and starting a game machine to proceed a game, the game machine having a plurality of wheels arranged in a juxtaposed fashion to generate a card set in which each wheel randomly presenting a card symbol;
judging through a card symbol judging unit whether the card symbol of the card set having a specific card symbol combination, and providing a selected amount of a bonus game to be proceeded on the game machine when the card symbol of the card set having met a special requirement, and counting alignment scores and tallying accumulating points in the event of non-conforming to the special requirement to proceed the game of a next round;
rotating the wheels to proceed the bonus game in which each wheel in the card set randomly presenting a special card symbol selected from the specific card symbol combination;
recording and collecting the presented special card symbol and counting the alignment scores to get the points; and
detecting existing of a remained amount of the bonus game and repeating rotation of the wheels to count the alignment scores and recording and collecting new appearing of the special card symbol through the card symbol collecting unit until the amount of the bonus game is used up, and judging whether the all special card symbols in the specific card set combination have been collected based on the collected special card symbol recorded by the card symbol collecting unit to determine whether to grant additional points and an extra amount of the bonus game.

7. The method of claim 6, wherein the grant an extra amount of the bonus game generates at least one round of the collectable bonus game to repeat rotation of the wheels to count the alignment scores to get more points until the amount of bonus game is used up and judge whether all the special card symbols required to be collected have been collected based on recording of the card symbol collecting unit to determine whether points collection is finished and count final other additional points being granted and leave the bonus game.
